(19) United States
(12) Patent Application Publication
(10) Pub. No.: US 2003/0074128 A1
(43) Pub. Date: Apr. 17, 2003

(54) Airport traffic control system

(76) Inventor: Aris Mardirossian, Germantown, MD (US)

Correspondence Address: NIXON & VANDERHYE, PC, 1100 N GLEBE ROAD, 8TH FLOOR, ARLINGTON, VA, 22201-4714, US

(21) Appl. No.: 09/977,242

(22) Filed: Oct. 16, 2001

(51) Int. Cl. G08G 5/06

(52) U.S. Cl. 701/120; 342/36

(57) ABSTRACT

A method and/or system for improving safety of airport ground traffic (i.e., airplanes taxiing on the ground at airports). In certain example embodiments, an air traffic controller (ATC) instructs a particular airplane as to which runway(s)/taxiway(s) to use during either taxiing procedures to a gate, or taxiing procedures to a takeoff runway. The instructions associated with this plane are entered (e.g., by the ATC) into an ATC computer. As the plane is taxiing at the airport, it continuously or periodically sends its position data (obtained via GPS) in a wireless manner to an ATC computer. Utilizing the plane's position data in combination with the taxiway/runway directions given to that plane, traffic light(s) at airport intersection(s) are controlled. Thus, for example, when this plane approaches a particular airport intersection, a traffic light at the intersection indicates to the plane which direction it is to go (i.e., stop, go straight ahead, turn right, or turn left). In such a manner, the likelihood of airplanes colliding with one another while they are taxiing at an airport can be significantly reduced.

This invention relates to a system and corresponding method for controlling airplane traffic on runways and/or taxiways at airports. More particularly, this invention relates to a system and corresponding method for utilizing position data (e.g., obtained via GPS or any other suitable technique) associated with a particular airplane in order to control runway/taxiway traffic light(s) so that when that particular airplane approaches an airport intersection, the airplane traffic light(s) at the intersection indicate to the airplane which way to proceed.

### BACKGROUND OF THE INVENTION

A typical airport has at least one runaway as well as at least one taxiway. Generally, an air traffic controller (ATC) provides each airplane with instructions as to which taxiway(s) and/or runway(s) to use both before takeoff and after landing. Thus, after a plane lands at an airport, for example, it is or has been instructed as to which runway/taxiway(s) to use in order to reach the ultimate destination gate. Likewise, as a plane leaves a gate in preparing to takeoff, an ATC provides (or has already provided) the plane with instructions as to which taxiway(s) to utilize in reaching the runway to be utilized for takeoff.

Unfortunately, a potential exists for airplanes to collide with one another at airport intersections. Herein, an “intersection” means a location where a taxiway meets another taxiway or runway, or a location where a runway meets another runway or taxiway at an airport. This potential for collision exists especially when a pilot of a particular plane forgets (or misunderstands due to language problems/barriers) which runway and/or taxiway the plane is to use when proceeding either to a gate or to an ultimate takeoff runway.

Accordingly, those skilled in the art will recognize that there exists a need in the art for a system and/or method for improving safety at airports. Additionally, there exists a need in the art for a method and/or system for reducing the likelihood of planes colliding with one another while taxiing on the ground at airports.

### SUMMARY OF THE INVENTION

It is an object of this invention to provide a system and/or method which reduces the likelihood of airplanes colliding with one another during taxiing on the ground at airport(s).

Another object of this invention is to utilize position data associated with a particular airplane (e.g., obtain via GPS, Loran, or any other suitable technique) in order to control traffic light(s) located at airport intersection(s) so that when the plane approaches an intersection a traffic light(s) at that intersection indicates to the plane which way to go/proceed.

Another object of this invention is to fulfill one or more of the above-listed objects and/or needs.

Generally speaking, certain example embodiments of this invention fulfill one or more of the above-listed objects and/or needs by providing a system for controlling ground airplane traffic at an airport, the system comprising: at least one compute utilizing (a) position data received from an airplane at the airport, and (b) directional instructions relating to the airplane, in order to control at least one traffic light at an airport intersection so that the light instructs the airplane which way to proceed at the intersection.

Certain other embodiments of this invention fulfill one or more fo the above listed objects and/or needs by providing a method of controlling airplane traffic on the ground at an airport, the method comprising: providing the airport with at least one intersection, the intersection being defined by a location where at least one runway or taxiway meets with or crosses another runway or taxiway; and at least one computer utilizing position data received from an airplane at the airport in order to cause at least one traffic light at the intersection to be controlled in order to instruct the airplane as to which direction to proceed at the intersection.

### BRIEF DESCRIPTION OF THE DRAWINGS

FIG. 1 is a block diagram of an airport traffic control system according to an embodiment of this invention.

FIG. 2 is a flow chart illustrating steps which are carried out when implementing the FIG. 1 embodiment.

FIG. 3 is a top plan view of an airport, including at least one runway and a plurality of taxiways, in the context of which the system/method of FIGS. 1-2 may be utilized according to an embodiment of this invention.

### DETAILED DESCRIPTION OF CERTAIN EMBODIMENTS OF THIS INVENTION

Referring now more particularly to the accompanying drawings in which like reference numerals indicate like parts throughout the several views.

The instant invention relates to a method and/or system for improving safety of airport ground traffic (i.e., airplanes taxiing on the ground at airports). In certain example embodiments, an air traffic controller (ATC) instructs a particular airplane as to which runway(s)/taxiway(s) to use during either taxiing procedures to a gate, or taxiing procedures to a takeoff runway. The instructions associated with this plane are entered (e.g., by the ATC) into an ATC computer. As the plane is taxiing at the airport, it continuously or periodically sends its position data (obtained via GPS) in a wireless manner to an ATC computer. This or another ATC computer utilizes the plane's position data in combination with the taxiway/runway directions given to that plane, and controls traffic light(s) at airport intersection(s) accordingly. Thus, for example, when this plane approaches a particular airport intersection, a traffic light at that intersection indicates to the plane which direction it is to go (i.e., stop, go straight ahead, turn right, or turn left). In such a manner, the likelihood of airplanes colliding with one another while they are taxiing at an airport can be significantly reduced.

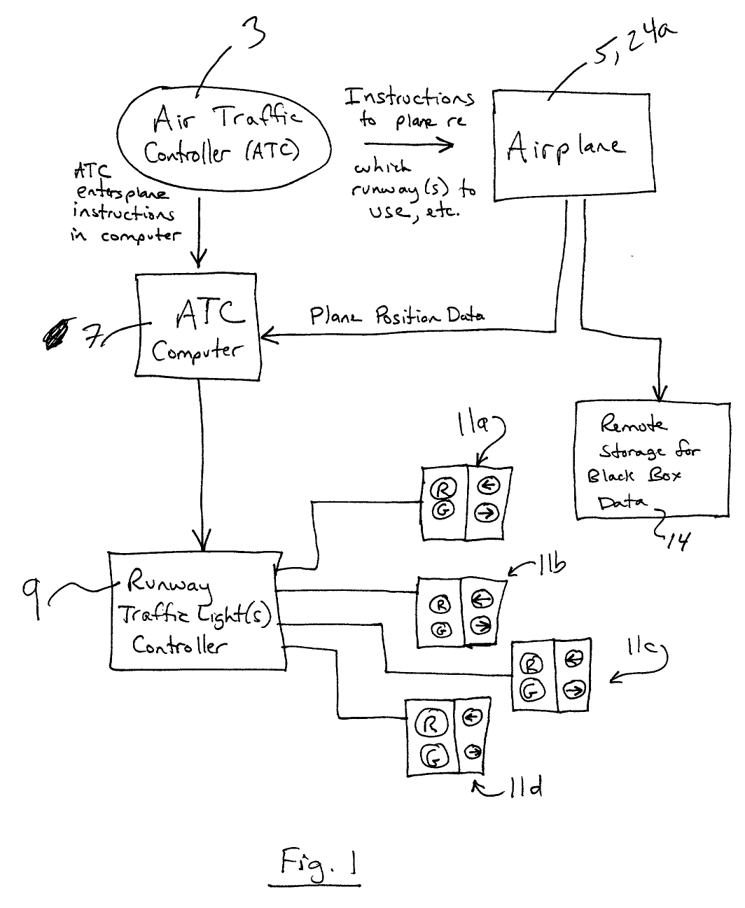

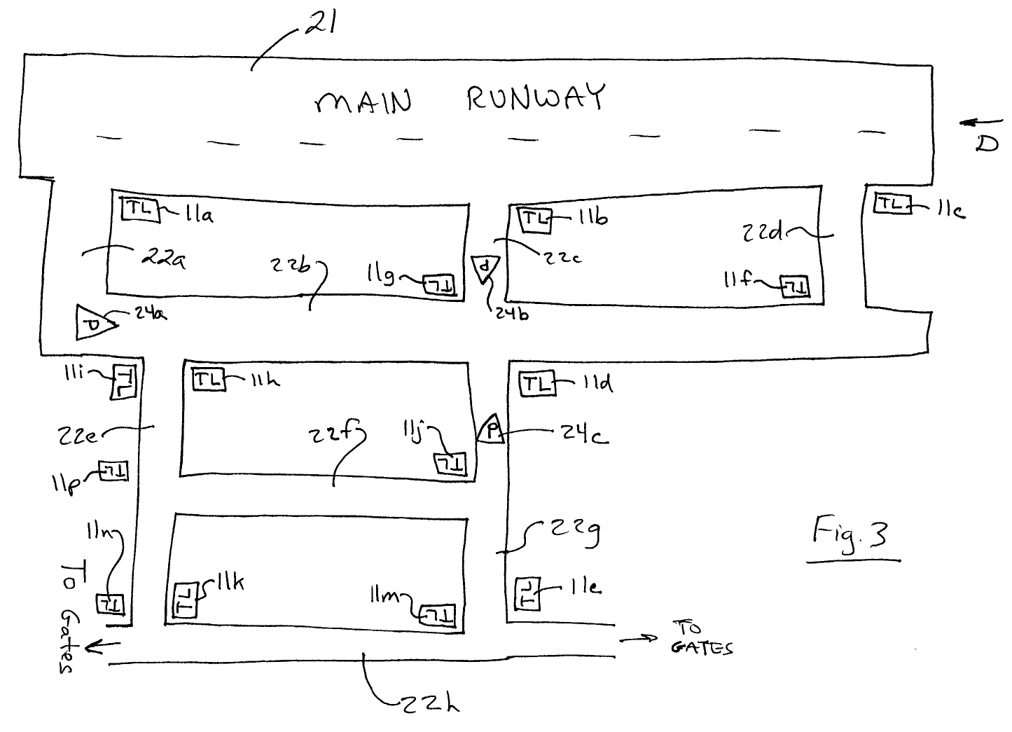

FIG. 1 is a block diagram of an example embodiment of this invention. As shown, the system includes at least one air traffic controller (ATC) 3, at least one airplane 5, 24, at least one ATC computer 7, at least one runway traffic light controller 9, a plurality of different airport traffic lights 11 which are located at different respective intersections at the airport (see FIG. 3), and remote storage 14 for storing black box data transmitted from the airplane 5, 24 to a remote location where the storage 14 is located.

Referring to FIG. 3, it can be seen that the airport includes at least one primary or main runway 21, as well as a plurality of different taxiways 22a-22h. Airplanes 24 are periodically and/or continuously moving about taxiways 22 and/or runway(s) 21 in order to (a) move into a position for takeoff, or (b) move to a gate to unload passengers after landing/arrival. At least one traffic light (TL) 11a-11p is located at each of a plurality of different intersections. In certain embodiments, each airport intersection may has a traffic light (TL) associated therewith, while in other embodiments only certain intersections may have traffic lights associated therewith.

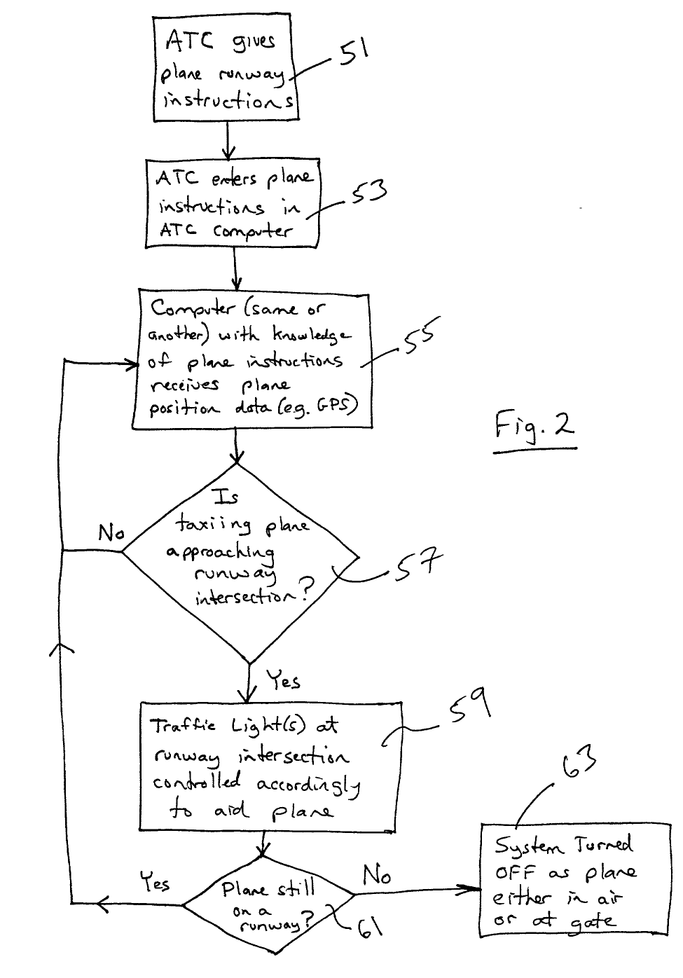

Referring to FIGS. 1-3, an example operation of a system/method according to the instant invention will now be described. This particular example is not intended to be limiting. Assume that airplane 24a lands on main runway 21 in direction D. After the airplane 24a lands and proceeds to the end of runway 21, it turns left onto taxiway 22a. At or before turning onto taxiway 22a, an air traffic controller (ATC) 3 radios directions/instructions to airplane 24a which includes directional instructions telling the pilot(s) which runway(s)/taxiway(s) to use when proceeding to the gate. See step 51 in FIG. 2. After, before, or while the ATC provides airplane 24a with these directional instructions, the ATC enters these same instructions (i.e., relating to the path the plane is to take to the gate) into ATC computer 7 where the instructions are stored in memory. See step 53 in FIG. 2.

When plane 24a is on the ground, it continuously or periodically sends its position data (e.g., GPS position data) to an air traffic control computer such as ATC computer 7, using a transponder. See step 55 in FIG. 2. ATC computer 7 utilizes the position data from plane 24a as well as the directions for that plane which the computer is storing, in the following manner. Using the position data relating to plane 24a, ATC computer 27 makes a determination as to whether or not the taxiing plane 24a is approaching an airport intersection. See step 57 in FIG. 2. For example, when plane 24a is on taxiway 22b, as shown in FIG. 3, ATC computer 7 determines whether or not plane 24a is approaching the intersection defined by taxiway 22b and taxiway 22e (this intersection is served by traffic light 11i). If the plane is not approaching an airport intersection, then the system returns to step 55 as shown in FIG. 2.

However, if it is determined in step 57 that airplane 24a is approaching an intersection (as in FIG. 3, where the plane is approaching the intersection defined by taxiways 22b and 22e), then ATC computer 7 and/or runway traffic light controller 9 cause(s) traffic light 11i at that intersection to indicate to the plane 24a which direction to proceed. For example, if plane 24a has been instructed to proceed down taxiways 22a and 22b, to then make a right onto taxiway 22e, and thereafter a right onto taxiway 22h in order to reach its gate, then traffic light 11i at the intersection illustrated in FIG. 3 will indicate to plane 24a as it approaches the intersection between taxiways 22b and 22e, that the plane is to turn right off of taxiway 22b onto taxiway 22e. The traffic light 11i may make such an indication by illuminating a right turn arrow (see FIG. 1). See step 59 in FIG. 2.

Alternatively, if an ATC suddenly sees a plane going the wrong direction on taxiway 22e (i.e., going directly toward the intersection between taxiways 22e and 22b), the ATC can instruct computer 7 and/or controller 9 to cause light 11i to instruct plane 24a to stop (e.g., in this case, the light can cause a red R signal to be illuminated).

So long as the plane 24a is still on a runway or taxiway (i.e., as long as it has not taken off and is not at a gate), this process continues so that the traffic light(s) 11 can direct the plane back to the gate or the ultimate takeoff runway. See step 61 in FIG. 2. Once the plane has reached its gate (or taken off), the system may be turned off. See step 63 in FIG. 2.

The precise circuitry illustrated and described herein is provided for purposes of example only. It is not intended to be limiting. Additionally, it is noted that in certain embodiments of this invention traffic lights 11 are located at each airport intersection, while alternative embodiments of this invention one or more traffic lights 11 is/are located at only a fraction of the airport intersections (e.g., only at intersections prone to accidents, or intersections which are busy/dangerous).

In certain other embodiments of this invention, if it is determined by an ATC that a problems exists in a particular plane (e.g., that is has been hijacked, or if the pilot has been incapacitated), the data stored in storage 14 may be accessed and the plane may be remotely controlled in order to cause it to proceed to its destination gate as described above.

Once given the above disclosure, many other features, modifications, and improvements will become apparent to the skilled artisan. Such other features, modifications, and improvements, are thus considered to be a part of this invention, the scope of which is to be determined by the following claims and equivalents thereof.

I claim:

1. A method of controlling airplane traffic on the ground at an airport, the method comprising:
providing the airport with at least one intersection, the intersection being defined by a location where at least one runway or taxiway meets with or crosses another runway or taxiway;
at least one computer utilizing position data received from an airplane at the airport in order to cause at least one traffic light at the intersection to be controlled in order to instruct the airplane as to which direction to proceed at the intersection.

2. The method of claim 1, wherein taxiway directions provided to the airplane are stored in memory, and the position data received from the airplane is used in conjunction with the taxiway directions in order to control operation of the traffic light.

3. The method of claim 1, wherein the traffic light comprises means for instructing the airplane to turn right at the intersection, means for instructing the airplane to turn left at the intersection, and means for telling the airplane to stop at the intersection.

4. The method of claim 3, wherein the traffic light further comprises means for instructing the airplane to go straight through the intersection.

5. The method of claim 3, wherein said means for instructing the airplane to turn right at the intersection is a right hand arrow which may be selectively illuminated.

6. A system for controlling ground airplane traffic at an airport, the system comprising:
at least one intersection at the airport defined by a location where at least one runway or taxiway meets with or crosses another runway or taxiway; and
at least one compute that utilizes position data received from an airplane at the airport in order to cause at least one traffic light at the intersection to be controlled in order to instruct the airplane as to which direction to proceed at the intersection.

7. The system of claim 6, wherein taxiway directions provided to the airplane are stored in memory, and the position data received from the airplane is used in conjunction with the taxiway directions in order to control operation of the traffic light.

8. A system for controlling ground airplane traffic at an airport, the system comprising: at least one compute utilizing (a) position data received from an airplane at the airport, and (b) directional instructions relating to the airplane, in order to control at least one traffic light at an airport intersection so that the light instructs the airplane which way to proceed at the intersection.
